(19) United States
(12) Patent Application Publication
(10) Pub. No.: US 2025/0068937 A1
(43) Pub. Date: Feb. 27, 2025

(54) SYSTEM AND METHOD FOR DETERMINING VERIFICATION CHARACTERISTICS OF AN ADVANCED COMPUTATIONAL MODEL FOR DATA ANALYSIS AND AUTOMATED DECISION-MAKING

(71) Applicant: BANK OF AMERICA CORPORATION, Charlotte, NC (US)

(72) Inventors: Malinda Kieffer, Chillicothe, MO (US); Tanya A. Wilson, Newark, DE (US); Susan J. Moss, Vestal, NY (US); Andrzej Grabski, Glen Rock, NJ (US); Kiran Boosetty, Jacksonville, FL (US); Donna Lee Phillips, Elkton, MD (US); Gerard P. Gay, Seattle, WA (US); Robert Ronald Rosseland, Jr., Huntersville, NC (US); Ravinder Kaur Sodhi, Dallas, TX (US); Rahul Kumar Mishra, Skillman, NJ (US); Samuel M. Moiyallah, Jr., Newark, DE (US)

(73) Assignee: BANK OF AMERICA CORPORATION, Charlotte, NC (US)

(21) Appl. No.: 18/237,729

(22) Filed: Aug. 24, 2023

(51) Int. Cl. G06N 5/022

(52) U.S. Cl. CPC G06N 5/022

(57) ABSTRACT

Systems, computer program products, and methods are described herein for determining verification characteristics of an advanced computational model for data analysis and automated decision-making. The present disclosure is configured to receive, from a user device, a user prompt, wherein the user device is associated with a user. Further, the present disclosure is configured to receive one or more verification questions. Further still, the present disclosure is configured to interrogate, in response to receiving the one or more verification questions, an artificial intelligence model. Further still, the present disclosure is configured to receive, in response to interrogating the artificial intelligence model, one or more verification answers. Further still, the present disclosure is configured to analyze the one or more verification answers. Further still, the present disclosure is configured to generate a verification interface component, wherein the verification interface component comprises data associated with the one or more verification answers.

### TECHNOLOGICAL FIELD

Example embodiments of the present disclosure relate to determining verification characteristics of an advanced computational model for data analysis and automated decision-making.

### BACKGROUND

Verification of an artificial intelligence model can pose a significant challenge. Applicant has identified a number of deficiencies and problems associated with determining verification characteristics of an advanced computational model for data analysis and automated decision-making. Through applied effort, ingenuity, and innovation, many of these identified problems have been solved by developing solutions that are included in embodiments of the present disclosure, many examples of which are described in detail herein

### BRIEF SUMMARY

Systems, methods, and computer program products are provided for determining verification characteristics of an advanced computational model for data analysis and automated decision-making.

Embodiments of the present invention address the above needs and/or achieve other advantages by providing apparatuses (e.g., a system, computer program product, and/or other devices) and methods for determining verification characteristics of an advanced computational model for data analysis and automated decision-making. The system embodiments may comprise a processing device and a non-transitory storage device containing instructions when executed by the processing device, to perform the steps disclosed herein. In computer program product embodiments of the invention, the computer program product comprises a non-transitory computer-readable medium comprising code causing an apparatus to perform the steps disclosed herein. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the steps disclosed herein.

In some embodiments, the present invention receives, from a user device, a user prompt, wherein the user device is associated with a user. In some embodiments, the present invention receives one or more verification questions. In some embodiments, the present invention interrogates, in response to receiving the one or more verification questions, an artificial intelligence model. In some embodiments, the present invention receives, in response to interrogating the artificial intelligence model, one or more verification answers. In some embodiments, the present invention analyzes the one or more verification answers. In some embodiments, the present invention generates a verification interface component, wherein the verification interface component comprises data associated with the one or more verification answer.

In some embodiments, receiving the one or more verification questions includes determining, in response to receiving the user prompt, a prompt category; and receiving, in response to determining the prompt category, the one or more verification questions, wherein the one or more verification questions are associated with the prompt category.

In some embodiments, analyzing the one or more verification answers includes comparing the one or more verification answers with one or more established answers; and determining a verification score.

In some embodiments, executing the instructions further causes the processing device to transmit, to the user device, the verification interface component, wherein the verification interface component configures a graphical user interface of the user device.

In some embodiments, transmitting the verification interface component comprises transmitting the verification score.

In some embodiments, transmitting the verification interface component comprises transmitting the one or more verification answers.

In some embodiments, the one or more verification questions are received from a verification question repository.

In some embodiments, the present invention receives, in response to the artificial intelligence model failing the one or more verification questions, one or more additional verification questions from the verification question repository. In some embodiments, the present invention interrogates the artificial intelligence model with the one or more additional verification questions. In some embodiments, exe the present invention receives one or more additional verification answers. In some embodiments, the present invention determines an additional verification score.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for determining verification characteristics of an advanced computational model for data analysis and automated decision-making, in accordance with an embodiment of the disclosure;

FIG. 2 illustrates a process flow for generating a verification interface component, in accordance with an embodiment of the disclosure.

FIG. 3 illustrates a process flow for determining an additional verification score, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

Presently, it is increasingly difficult to determine the accuracy of artificial intelligence models. With the emergence of artificial intelligence models, and the increase in their use-cases (e.g., the number of ways the artificial intelligence models can be applied), the issue of trusting an artificial intelligence model has never been greater. Artificial intelligence models can generate confabulations (e.g., falsehoods, inaccuracies, and/or the like) just as easily as they can generate truthful answers. Differentiating between what is a confabulation and what is a truthful answer requires extensive knowledge on the particular subject matter. Without a way to ensure artificial intelligence models are not producing false or misleading information, a danger exists to those who use artificial intelligence models. Therefore, a need exists to verify artificial intelligence models with respect to the subject matter the artificial intelligence model is interrogated about.

Embodiments of the present disclosure provide for determining verification characteristics of an advanced computational model for data analysis and automated decision-making. In this regard, and by way of non-limiting example, the system (e.g., the verification determination system) may receive a user prompt (e.g., a question from a user). The system may receive one or more verification questions (e.g., questions that test the artificial intelligence model's accuracy on a particular subject matter) and present those questions to the artificial intelligence model. The system may determine a verification score based on the verification answers (e.g., the answers to the verification questions provided by the artificial intelligence model). In response to the verification score, the system may present the artificial intelligence model with additional questions. The system may show the user the verification score as well as the verification answers by displaying them on the user device.

What is more, the present disclosure provides a technical solution to a technical problem. As described herein, the technical problem includes determining whether the output from artificial intelligence models is verified information. The technical solution presented herein allows for accurate, effective, and efficient verification of an advanced computational model for data analysis and automated decision-making. In particular, the verification determination system (e.g., similar to system 130) is an improvement over existing solutions to the problem of artificial intelligence model output verification, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

In addition, the verification determination system (e.g., system 130), as described herein solves the problem of the issues arising from current artificial intelligence modeling technologies. Specifically, current artificial intelligence technologies suffer from confabulations (as discussed above), a lack of explanation in the techniques used to train the artificial intelligence model, and malicious use of such artificial intelligence technologies to generate false or misleading information. Therefore, the improvement disclosed herein develops a verification determination system (e.g., system 130) to specifically improve the functionality and capability of an advanced computational model for data analysis and automated decision-making. In this way, the verification determination system verifies an artificial intelligence model's capability through the verification process, as described herein. Further, the verification determination system (e.g., system 130) conserves resources throughout the process by reducing resources (e.g., computing resources, network resources, memory resources, storage resources, human resources, and/or the like) that would otherwise be consumed to determine the veracity of an artificial intelligence model.

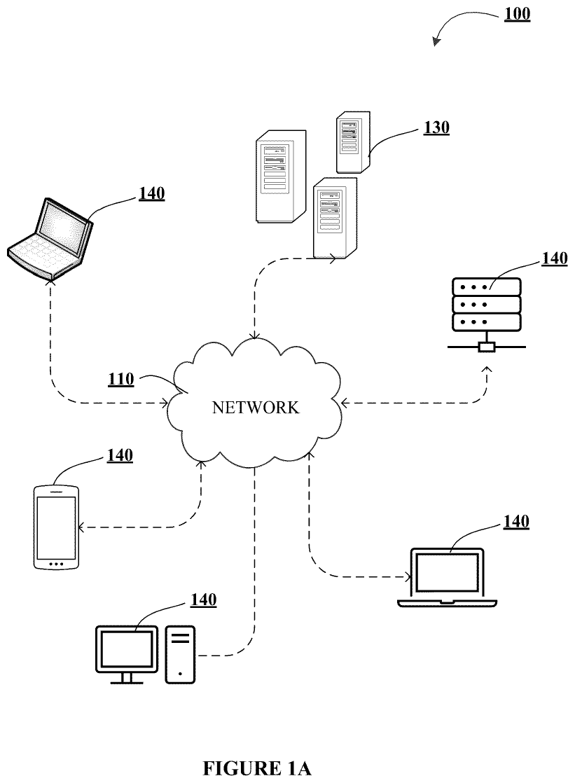

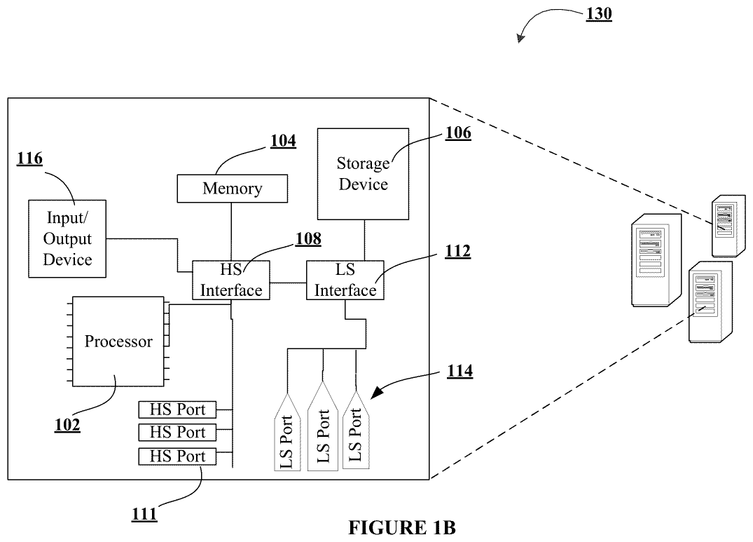

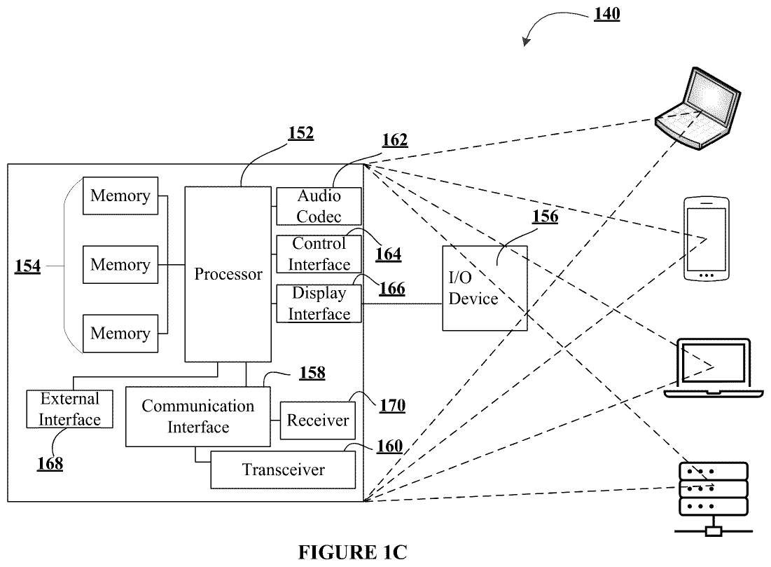

FIGS. 1A-1C illustrate technical components of an exemplary distributed computing environment for determining verification characteristics of an advanced computational model for data analysis and automated decision-making 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology. The network 110 may include one or more wired and/or wireless networks. For example, the network 110 may include a cellular network (e.g., a long-term evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, storage device 106, a high-speed interface 108 connecting to memory 104, high-speed expansion points 111, and a low-speed interface 112 connecting to a low-speed bus 114, and an input/output (I/O) device 116. The system 130 may also include a high-speed interface 108 connecting to the memory 104, and a low-speed interface 112 connecting to low-speed port 114 and storage device 106. Each of the components 102, 104, 106, 108, 111, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130, may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 may store information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low-speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router (e.g., through a network adapter).

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 156, 158, 160, 162, 164, 166, 168 and 170, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156 (e.g., input/output device 156). The display 156 may be, for example, a Thin-Film-Transistor Liquid Crystal Display (TFT LCD) or an Organic Light Emitting Diode (OLED) display, or other appropriate display technology. An interface of the display may include appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a Single In Line Memory Module (SIMM) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, near-field communication (NFC), and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

Further, communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications.

In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

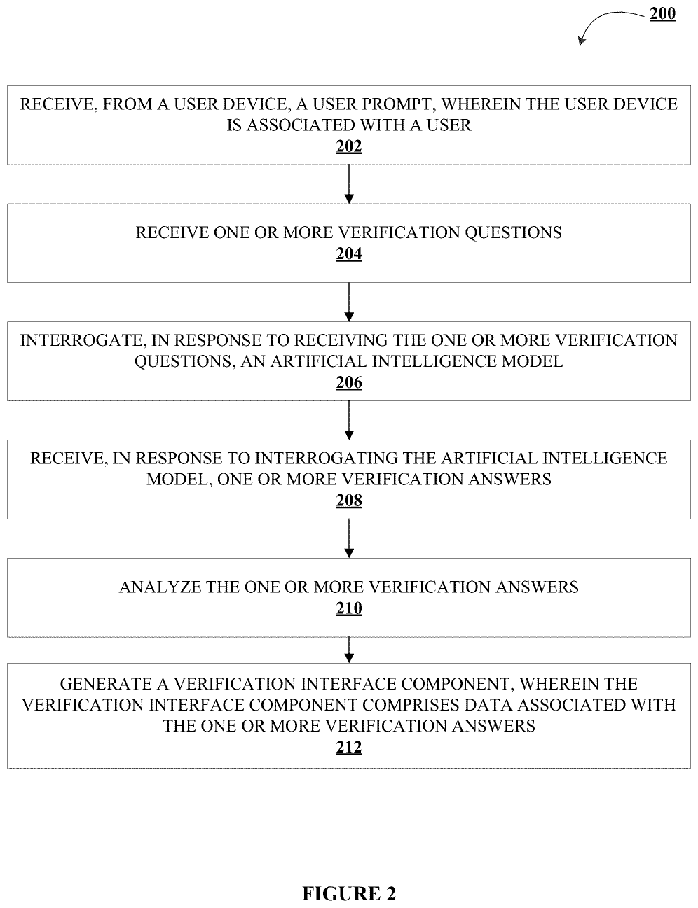

FIG. 2 is a process flow 200 which illustrates a process flow for generating a verification interface component, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, a verification determination system (e.g., similar to one or more of the systems described herein with respect to FIGS. 1A-1C) may perform one or more of the steps of process flow 200. For example, a verification determination system (e.g., the system 130 described herein with respect to FIGS. 1A-1C) may perform the steps of process flow 200.

As shown in block 202, the process flow 200 of this embodiment includes receiving, from a user device, a user prompt, wherein the user device is associated with a user. As used herein, a “user device” may include a variety of devices that may include one or more end-point devices (e.g., end-point device(s) 140, or the like). In some embodiments, the user device may or may not be associated with the user. For instance, and by way of non-limiting example, the user device may be associated with the user, which may include a personal mobile telephone, a personal computer, a personal tablet, and/or the like. In another instance, and by way of non-limiting example, the user device may not be associated with the user, such as a public computer, a public telephone, a public tablet, and/or the like.

As used herein, a “user prompt” may include any information presented to the verification determination system by the user (e.g., the system 130). For instance, and by way of non-limiting example, the user prompt may include information in an electronic format, such as a text message, a user input into a text box, a user input into a chat box feature, an email communication, and/or the like. In some embodiments, the user may enter the user prompt into an interface of the verification determination system. In some embodiments, the user prompt may include using the user's voice to transmit the user prompt. For instance, and by way of non-limiting example, the user may provide the user prompt during telephonic communications, a voicemail, a speech-to-text feature, and/or the like.

In some embodiments, the response of the verification determination system to the user prompt may include an output answer. As used herein, the “output answer” may include a response to the user prompt, which may include the response from the artificial intelligence model the user initially interacted with (e.g., the artificial intelligence model to which the user prompt was submitted).

As shown in block 204, the process flow 200 of this embodiment includes receiving one or more verification questions. As used herein, “one or more verification questions” may include questions to determine the data analysis and automated decision-making ability of the artificial intelligence model. In some embodiments, the one or more verification questions may vary in specificity. For instance, and by way of non-limiting example, the one or more verification questions may be less specific (e.g., more generalized) than the prompt category, the same specificity of the prompt category, more specific than the prompt category, some combination of generality and/or specificity, and/or the like.

In some embodiments, the one or more verification questions may be received from a verification question repository. In some embodiments, the verification question repository may include one or more verification questions and their established answers.

In some embodiments, the one or more verification questions may include pre-created questions (e.g., created by a manager of the verification determination system, a technician of the verification determination system, and/or the like), common or well-known questions, questions verified from a trusted source, and/or the like. In some embodiments, the one or more verification questions may verify that the artificial intelligence model has an accurate understanding of the subject matter (e.g., prompt category) of the user prompt. In some embodiments, the number of verification questions used to interrogate the artificial intelligence model may be adjusted. In some embodiments, the number of verification questions used may be based on a particular prompt category, user preference, entity preference, and/or the like.

In some embodiments, receiving the one or more verification questions includes determining, in response to receiving the user prompt, a prompt category. In some embodiments, receiving the one or more verification questions includes receiving, in response to determining the prompt category, the one or more verification questions, wherein the one or more verification questions are associated with the prompt category.

As used herein, a “prompt category” may include a categorization of the user prompt, which may include a categorization of the subject matter of the user prompt. In some embodiments, the verification determination system may determine the prompt category in response to the user prompt. In some embodiments, the verification determination system may determine the prompt category in response to the user's previous prompts, if any.

In some embodiments, the verification determination system may determine the prompt category in response to one or more user characteristics. In this way, the verification determination system may receive one or more user characteristics, wherein the user characteristics may include the user's internet browsing history, the user's communications (e.g., text messages, email communications, phone calls, interactions with websites, and/or the like), location data, and/or the like. Further, in some embodiments, the verification determination system may analyze the one or more user characteristics to determine the prompt category. For instance, and by way of non-limiting example, if a user's internet browsing history reflects the user was browsing for scientific articles on a particular subject, the verification determination system may define the prompt category as science.

In some embodiments, the prompt category may include a sensitivity level. In some embodiments, the sensitivity level may relate to the subject matter of the prompt category.

In this way, the sensitivity level may include determining whether the prompt category contains sensitive information. As used herein, sensitive information may include information associated with an entity's confidential information, an entity's business secrets, an entity's internal procedures, an individual's confidential information, and/or the like. For instance, and by way of non-limiting example, if the prompt category relates to an important internal procedure of an entity (e.g., a corporation, business, company, and/or the like), then the verification determination system may determine a high sensitivity level of the prompt category. In this way, the sensitivity level may relate to the information contained in the user prompt and/or in the output answer.

As shown in block 206, the process flow 200 of this embodiment includes interrogating, in response to receiving the one or more verification questions, an artificial intelligence model. In some embodiments, interrogating the artificial intelligence model may include presenting the artificial intelligence model the one or more verification questions. In some embodiments, interrogating the artificial intelligence model may include presenting the artificial intelligence model a specified number of verification questions. For instance, and by way of non-limiting example, the verification determination system may interrogate the artificial intelligence model with one, two, three, four, five, six, seven, eight, nine, or ten verification questions. In some embodiments, the verification questions used to interrogate the artificial intelligence model may relate to the prompt category. For instance, if the prompt category relates to science, then the verification questions may relate to science, as well. In some embodiments, the one or more verification questions may include a subset of baseline questions. In some embodiments, the artificial intelligence model's response to the baseline questions (e.g., verification answers) may determine general functionality of the artificial intelligence model, overall system capability. In some embodiments, the baseline questions may not necessarily be within the prompt category.

In some embodiments, the one or more verification questions may be randomized. In some embodiments, the one or more verification questions may be randomized while still being within the subject matter of the prompt category. For instance, and by way of non-limiting example, if the prompt category was science, the one or more verification questions may be randomized within the subject matter of science. In this way, the randomization of the verification questions may limit the ability of the artificial intelligence model to learn trends associated with the interrogation process.

In some embodiments, the one or more verification questions may comprise verification question characteristics. In some embodiments, the verification question characteristics may include the verification question's difficulty, specificity, purpose, conciseness, neutrality, and/or the like. In some embodiments, the verification question characteristics may be adjusted in response to the user prompt. For instance, and by way of non-limiting example, if a user prompt is determined to have a high sensitivity level, the verification question characteristics may be adjusted to match the level of sensitivity associated with the user prompt.

As shown in block 208, the process flow 200 of this embodiment includes receiving, in response to interrogating the artificial intelligence model, one or more verification answers. As used herein, one or more verification answers may include answers from the artificial intelligence model in response to the verification answers. In this way, the artificial intelligence model may respond to the verification questions with the verification answers, as produced by the artificial intelligence model. In some embodiments, the one or more verification answers may answer each of the one or more verification questions, respectively. For instance, and by way of non-limiting example, if the verification determination system interrogates the artificial intelligence model with ten verification questions, the artificial intelligence model may generate ten verification answers.

As shown in block 210, the process flow 200 of this embodiment includes analyzing the one or more verification answers. In some embodiments, analyzing the one or more verification answers may include comparing the one or more verification answers with one or more established answers. As used herein, the one or more established answers may include answers to the verification questions that are known answers to the verification questions. In this way, the verification answers may be compared against the established answers to determine the accuracy and ability of the artificial intelligence model to answer questions.

In some embodiments, analyzing the one or more verification answers may include determining a verification score. As used herein, the “verification score” may be a representation of how many verification questions the artificial intelligence model answered correctly, as compared with the established answers. In this way, the artificial intelligence model may be given a score, which may include a percentage of verification questions answered correctly, the number of verification questions answered correctly, a pass or fail option, a named scale option (e.g., “exceeds expectations”, “meets expectations”, “needs improvement”, and/or the like), and/or the like.

In some embodiments, the verification determination system may perform an event monitoring procedure. In some embodiments, the event monitoring procedure may include comparing the verification score, the prompt category. In some embodiments, the event monitoring procedure may include compare the verification score, the prompt category, and/or the sensitivity level. For instance, and by way of non-limiting example, if the verification score is low and the sensitivity level is high, the verification determination system may review any and all information associated with the interaction between the user and the verification determination system. In this way, the user prompt, verification questions, verification answers, verification score, and/or output answer may be reviewed during the event monitoring procedure. In some embodiments, the event monitoring procedure may include a review process, wherein a manager of the verification determination system may review the verification score, prompt category, user prompt, and other information associated with the user's interaction with the verification determination system.

As shown in block 212, the process flow 200 of this embodiment includes generating a verification interface component, wherein the verification interface component comprises data associated with the one or more verification answers. In some embodiments, the verification determination system may transmit, to the user device, the verification interface component, wherein the verification interface component configures a graphical user interface of the user device.

In some embodiments, transmitting the verification interface component includes transmitting the verification score. In some embodiments, transmitting the verification interface component includes transmitting the one or more verification answers. In some embodiments, transmitting the verification interface component may include transmitting the one or more verification questions. In this way, the one or more verification questions and the one or more verification answers may be shown to the user.

In some embodiments, the verification determination system may transmit the verification interface component to the user device, wherein the user device may include a printing device. In this way, the user device may print the verification interface component, which may include the verification score, the one or more verification questions, and/or the one or more verification answers.

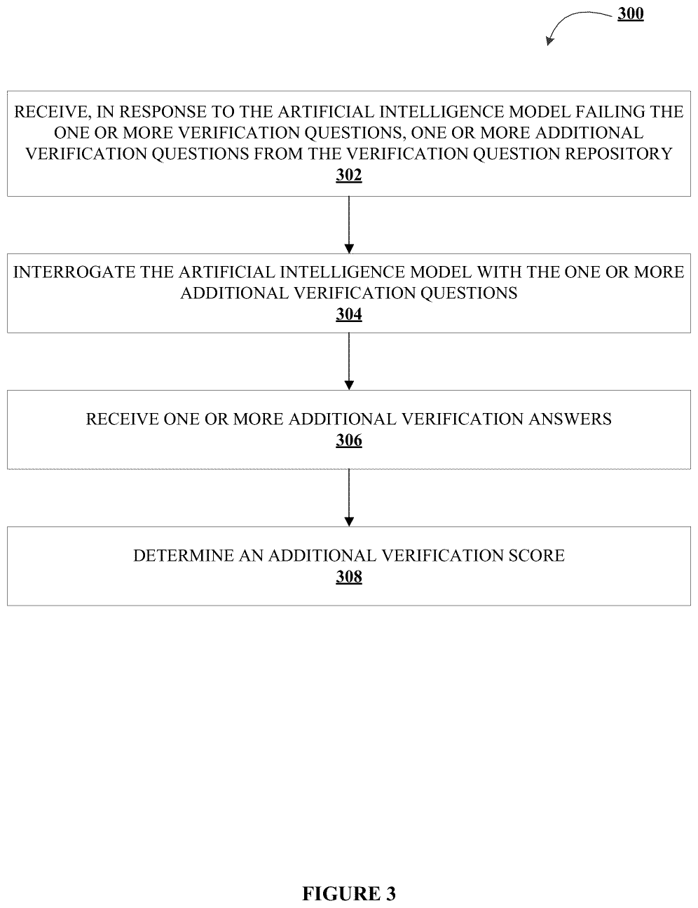

FIG. 3 is a process flow 300 which illustrates a process flow for determining an additional verification score, in accordance with an embodiment of the disclosure. The method may be carried out by various components of the distributed computing environment 100 discussed herein (e.g., the system 130, one or more end-point device(s) 140, etc.). An example system may include at least one processing device and at least one non-transitory storage device containing instructions that, when executed by the processing device, causes the processing device to perform the method discussed herein.

In some embodiments, a verification determination system (e.g., similar to one or more of the systems described herein with respect to FIGS. 1A-1C) may perform one or more of the steps of process flow 300. For example, a verification determination system (e.g., the system 130 described herein with respect to FIGS. 1A-1C) may perform the steps of process flow 300.

As shown in block 302, the process flow 300 of this embodiment includes receiving, in response to the artificial intelligence model failing the one or more verification questions, one or more additional verification questions from the verification question repository. In some embodiments, if the artificial intelligence model fails the one or more verification questions (e.g., the one or more verification answers do not match the one or more established answers), then one or more additional verification questions may be selected (e.g., randomly selected) from the verification question repository. For instance, and by way of non-limiting example, if the artificial intelligence model provides incorrect verification answers to three out of the ten verification questions, a number of additional verification questions may be selected at random from the verification question repository. In some embodiments, the one or more additional verification questions may not be the same as the one or more verification questions initially presented to the artificial intelligence model. In this way, the additional verification questions will be new verification questions the artificial intelligence model has not interacted with previously.

As shown in block 304, the process flow 300 of this embodiment includes interrogating the artificial intelligence model with the one or more additional verification questions. In some embodiments, interrogating the artificial intelligence model with the one or more additional verification questions may include interrogating the artificial intelligence model as soon as the verification determination system determines the artificial intelligence model failed the initial verification questions.

As shown in block 306, the process flow 300 of this embodiment includes receiving one or more additional verification answers.

As shown in block 308, the process flow 300 of this embodiment includes determining an additional verification score. In some embodiments, the additional verification score may include an accounting of the previous verification score. In this way, the verification determination system may show the user both the verification score and the additional verification score. For instance, and by way of non-limiting example, the verification determination system may show (e.g., display) the user the verification score and, in response to the artificial intelligence model failing the initial verification questions, the additional verification score.

In some embodiments, the additional verification score may be a separate and distinct score from the initial verification score. In this way, the additional verification score may not be influenced by the verification score initially determined by the verification determination system.

In some embodiments, the process of presenting the artificial intelligence model with additional verification questions, receiving additional verification scores, determining an additional verification score, and/or the like, may be an iterative process. In this way, the artificial intelligence model may be continuously presented with additional sets of additional verification questions until a satisfactory additional verification score is achieved. In some embodiments, the iterative process may include presenting the artificial intelligence model with additional verification questions, receiving additional verification scores, determining an additional verification score, and/or the like, one, two, three, four, five, six, seven, eight, nine, or ten times. For instance, and by way of non-limiting example, if the artificial intelligence model does not achieve a satisfactory additional verification score two times, then the verification determination system may present an additional set of one or more additional verification questions (e.g., a third iteration).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for determining verification characteristics of an advanced computational model for data analysis and automated decision-making, the system comprising:
a processing device;
a non-transitory storage device containing instructions that, when executed by the processing device, causes the processing device to perform the steps of:
receive, from a user device, a user prompt, wherein the user device is associated with a user;
receive one or more verification questions;
interrogate, in response to receiving the one or more verification questions, an artificial intelligence model;
receive, in response to interrogating the artificial intelligence model, one or more verification answers;
analyze the one or more verification answers; and
generate a verification interface component, wherein the verification interface component comprises data associated with the one or more verification answers.

2. The system of claim 1, wherein receiving the one or more verification questions comprises:
determining, in response to receiving the user prompt, a prompt category; and
receiving, in response to the prompt category, the one or more verification questions, wherein the one or more verification questions are associated with the prompt category.

3. The system of claim 1, wherein analyzing the one or more verification answers comprises:
comparing the one or more verification answers with one or more established answers; and
determining a verification score.

4. The system of claim 1, wherein executing the instructions further causes the processing device to transmit, to the user device, the verification interface component, and wherein the verification interface component configures a graphical user interface of the user device.

5. The system of claim 4, wherein transmitting the verification interface component comprises transmitting the verification score.

6. The system of claim 5, wherein transmitting the verification interface component comprises transmitting the one or more verification answers.

7. The system of claim 1, wherein the one or more verification questions are received from a verification question repository.

8. The system of claim 7, wherein executing the instructions further causes the processing device to:
receive, in response to the artificial intelligence model failing the one or more verification questions, one or more additional verification questions from the verification question repository;
interrogate the artificial intelligence model with the one or more additional verification questions;
receive one or more additional verification answers; and
determine an additional verification score.

9. A computer program product for determining verification characteristics of an advanced computational model for data analysis and automated decision-making, the computer program product comprising a non-transitory computer-readable medium comprising code causing an apparatus to:
receive, from a user device, a user prompt, wherein the user device is associated with a user;
receive one or more verification questions;
interrogate, in response to receiving the one or more verification questions, an artificial intelligence model;
receive, in response to interrogating the artificial intelligence model, one or more verification answers;
analyze the one or more verification answers; and
generate a verification interface component, wherein the verification interface component comprises data associated with the one or more verification answers.

10. The computer program product of claim 9, wherein receiving the one or more verification questions comprises:
determining, in response to receiving the user prompt, a prompt category; and
receiving, in response to determining the prompt category, the one or more verification questions, wherein the one or more verification questions are associated with the prompt category.

11. The computer program product of claim 9, wherein analyzing the one or more verification answers comprises:
comparing the one or more verification answers with one or more established answers; and
determining a verification score.

12. The computer program product of claim 9, wherein the code further causes the apparatus to transmit, to the user device, the verification interface component, and wherein the verification interface component configures a graphical user interface of the user device.

13. The computer program product of claim 12, wherein transmitting the verification interface component comprises transmitting the verification score.

14. The computer program product of claim 13, wherein transmitting the verification interface component comprises transmitting the one or more verification answers.

15. The computer program product of claim 9, wherein the one or more verification questions are received from a verification question repository.

16. The computer program product of claim 15, wherein the code further causes the apparatus to:
receive, in response to the artificial intelligence model failing the one or more verification questions, one or more additional verification questions from the verification question repository;
interrogate the artificial intelligence model with the one or more additional verification questions;
receive one or more additional verification answers; and
determine an additional verification score.

17. A method for determining verification characteristics of an advanced computational model for data analysis and automated decision-making, the method comprising:
receiving, from a user device, a user prompt, wherein the user device is associated with a user;
receiving one or more verification questions;
interrogating, in response to receiving the one or more verification questions, an artificial intelligence model;
receiving, in response to interrogating the artificial intelligence model, one or more verification answers;
analyzing the one or more verification answers; and
generating a verification interface component, wherein the verification interface component comprises data associated with the one or more verification answers.

18. The method of claim 17, wherein receiving the one or more verification questions comprises:
determining, in response to receiving the user prompt, a prompt category; and
receiving, in response to determining the prompt category, the one or more verification questions, wherein the one or more verification questions are associated with the prompt category.

19. The method of claim 17, wherein analyzing the one or more verification answers comprises:
comparing the one or more verification answers with one or more established answers; and
determining a verification score.

20. The method of claim 17, wherein the method further comprises transmitting, to the user device, the verification interface component, and wherein the verification interface component configures a graphical user interface of the user device.
